(19) United States
(12) Patent Application Publication
(10) Pub. No.: US 2022/0405698 A1
(43) Pub. Date: Dec. 22, 2022

(54) Systems and Methods for Inventory Management and Mobile Delivery

(71) Applicant: Eric Minicucci, Arroyo Grande, CA (US)

(72) Inventor: Eric Minicucci, Arroyo Grande, CA (US)

(21) Appl. No.: 17/695,926

(22) Filed: Mar. 16, 2022

Related U.S. Application Data
(60) Provisional application No. 63/213,379, filed on Jun. 22, 2021.

(51) Int. Cl. G06Q 10/08; G06Q 50/30; H04W 4/02; H04W 4/029; G06F 16/23

(52) U.S. Cl. CPC G06Q 10/087; G06Q 10/0833; G06Q 50/30; H04W 4/023; H04W 4/029; G06F 16/2358

(57) ABSTRACT

The present disclosure provides a dynamic mobile inventory management and delivery system. The system tracks the locations of and facilitates interactions with a set of mobile inventories, each carried by a respective vehicle and having an associated driver with a user device for accessing the system. Users can access this decentralized inventory via a web-based shopping portal hosted by the system servers, allowing them to determine which inventory items are currently in transit in their area and order those items while the mobile inventory containing them is still in close proximity for ‘just-in-time’ deliveries.

### CROSS REFERENCES TO RELATED APPLICATIONS

The present application claims the benefit and priority of U.S. provisional application No. U.S. 63,213,379, filed 22 Jun. 2021.

### FIELD OF INVENTION

The present invention generally relates to inventory management. More specifically, it relates to a system and related methods for dynamically managing a plurality of mobile inventories.

### BACKGROUND

The term “'fulfillment” in relation to goods shipments comes from the terms “order fulfillment” and “product fulfillment”, which were introduced by business management researchers who analyzed supply chains in the late 1980s. This label was then applied to picking warehouse companies, who regarded “fulfillment centre” or “fulfillment house” to be more positive and active than the old term “inventory warehouse.” These terms are still relatively new and unknown by people outside the industry and “warehouse” is often added in parenthesis or used as an alternative word in the same text, in order to explain to laymen what “fulfillment centre” or “fulfillment house” actually means.

Some companies, such as Amazon, have their own fulfillment centers, while many smaller e-commerce companies outsource their inventory, picking, packaging and shipping to external fulfillment companies. Many larger companies with their own fulfillment centers also handle warehousing and shipping for other sellers. Amazon itself is one such example, offering to handle warehousing and order fulfillment to third-party sellers. Another, very early example, was Fingerhut, which in the 1990s expanded its own fulfillment center in order to take on fulfillment services for other companies, including the company that eventually acquired Fingerhut: Federated Department Stores.

There are multiple types of fulfillment house. In the past, a fulfillment center was typically associated with filling larger commercial orders to a retailer or distributor. Today, with the growth of e-commerce, there are fulfillment centers that strictly focus on shipping small parcels direct-to-consumers. Additionally, some e-commerce fulfillment centers focus on a niche venue, such as small or large products, a specific type of product, or they only deal with a certain number of stock keeping units.

A subset of e-commerce known as drop shipping (a type of product fulfillment that occurs directly from manufacturers to consumers via 3rd party retail websites) utilizes the manufacturer's or a wholesaler's fulfillment centers to deliver goods to the client. In drop shipping, the company that generates the sale never handles the physical product, but it does pass on fulfillment requirements to the fulfillment house so that client demands like two-day shipping can be met.

While companies like Amazon have streamlined time frames for direct-to-consumer goods delivery with a vast array of fulfillment centers in many regions of the United States, deliveries can still take up to several days due to supply chain requirements such as inventory picking, packaging and truck deliveries. As delivery vehicles are not dynamically integrated into the supply chain by current systems, the routes they take between deliveries are not as optimized as they could be.

For example, in current systems, a user may log onto an app and purchase an item from a website while a vehicle that has just left a warehouse containing the desired item is nearby. The warehouse had no way of knowing that a user in that area would make such an order, and so did not load the item onto the vehicle. Another vehicle will now have to be sent to the same area, or the same vehicle will have to travel back to the warehouse, pick up the item, and then return to the area again.

Vehicles are not generally loaded with items for which no order has yet been made, because there are no systems available for dynamically tracking the location of the items carried by the vehicles and routing deliveries to users who request them. In the above example, even if the vehicle had contained the desired item, neither the user nor driver would have had any way of coordinating fulfilment of the order efficiently. A system for dynamically managing mobile inventories is needed that can enhance direct-to-consumer deliveries.

It is within this context that the present invention is provided.

### SUMMARY

The present disclosure provides a solution to the shortcomings in the prior art through a dynamic mobile inventory management and delivery system. The system tracks the locations of and facilitates interactions with a set of mobile inventories, each carried by a respective vehicle and having an associated driver with a user device for accessing the system. Users can access this decentralized inventory via a web-based shopping portal hosted by the system servers, allowing them to determine which inventory items are currently in transit in their area and order those items while the mobile inventory containing them is still in close proximity for ‘just-in-time’ deliveries.

An object of the system is thus to streamline e-commerce, and more specifically, direct-to-consumer supply chains.

Another object of the system is to provide a decentralized, open inventory that can be viewed directly by consumers by means of the shopping portal. For example, a client interested in an article of clothing can go to the website and view the mobile inventory in real time and see if the item is in their community at any given moment. If the item is not available within a particular radius, the software also presents similar options to promote cross-selling.

Another object of the invention is to allow a user to view mobile inventories on the web portal on multiple computer devices. For example, the client can use a desktop computer or smart phone to view where an item is within a local map with GPS capability displayed on these devices.

Another object of the invention is to allow drivers to promote sales. For example, a driver who happens to be in an area where business clients have made multiple purchases can pay such clients a personal visit and see if they might need any new items they happen to have in stock at that moment. Users who also institute the system can also provide commissions to drivers in order to boost sales.

Another object of the invention is to provide a means to allow drivers to solve inventory issues quickly using their mobile devices. For example, drivers can meet and exchange inventories to help fulfill orders in areas that drivers may happen to be more familiar with.

Thus, according to one aspect of the present disclosure there is provided a system for dynamically managing a mobile inventory, the system comprising: a plurality of user devices; a database configured to store data on the contents of a plurality of mobile inventories and to store user data for a plurality of user accounts, one or more of the user account being associated with a respective mobile inventory; and one or more servers in communication with the plurality of user devices and the database.

The one or more servers are configured to: receive inventory data indicating the addition or removal of one or more inventory items to a mobile inventory from a first user device associated with the mobile inventory; update the database based on the inventory data; determine the geographic location of the first user device; publish the geographic position of the first user device alongside the contents of the mobile inventory associated with the first user device to other user devices within a pre-defined area or distance from the first user device; receive a request from a second user device within the pre-defined area or distance of the first user device for one or more inventory items contained in the associated mobile inventory, the request comprising identifying data for a user account stored on the database; and determine and send a delivery address for the user account and the item requested to the first user device.

In some embodiments, the one or more servers are configured in coordination with the database to make accessible to the user devices a searchable list of inventory items, the distance of each inventory item from a user device accessing the list being calculated and displayed in real-time based on the geographic location of the user device and the geographic location of each user device associated with a mobile inventory containing the items.

In the case that an item on the searchable list is not within a predefined distance radius of a user device accessing the list, the one or more servers may be further configured to determine one or more similar items which are within the radius and present them to the user device.

In some embodiments, the one or more servers are further configured to display the positions of each mobile inventory within a pre-defined distance radius on a map to the one or more user devices based on the geographic positions of the user devices associated with the mobile inventories and the geographic position of the user device accessing the map.

In some embodiments, the one or more servers are further configured to enable user devices having associated mobile inventories to coordinate and exchange inventory items.

In some embodiments, the request is a purchase order and the one or more servers are further configured to transact the purchase prior to notifying the first user device of the request.

In some embodiments, the one or more servers and the database are part of a distributed cloud architecture.

In some embodiments, each user device associated with a mobile inventory is further provided with point-of-sale capabilities to facilitate the sale of additional inventory items on-location.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting. As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present.

By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE DRAWINGS

Various embodiments of the invention are disclosed in the following detailed description and accompanying drawings.

FIG. 1 illustrates an example interaction carried out according to the system of the present disclosure wherein a client determines that a desired item is in transit nearby and makes a purchase, which is notified to a mobile inventory driver.

FIG. 2 illustrates a functional overview of an example system according to the present disclosure and the network architecture over which it operates.

FIG. 3 illustrates a flow chart of an example set of steps carried out by a server in accordance with the system and methods of the present disclosure.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The term “user” as used herein can apply to both clients and distributors, as both clients and distributors may access the disclosed platform over a network via one or more “user devices” by logging into their respective “user account”. User accounts may be divided into client accounts and distributor accounts.

The present disclosure provides a system for managing a mobile inventory through which users can both purchase items in a standard direct-to-consumer delivery type service and track the locations of items contained in different mobile inventories and purchase them when they are nearby, thereby leading to increased efficiency of deliveries and order completion. The system is accessible by user devices over an e-commerce platform that facilitates the viewing, tracking, and purchasing of items in the mobile inventories. The mobile inventories are generally housed in vehicles with large storage capacity such as lorries and vans.

As discussed herein, the term “client account” generally refers to an account on the platform maintained on behalf of a client to facilitate at least one of tracking of their user data and selection and payment for one or more products.

As discussed herein, the term “distributor account” generally refers to an account on the platform maintained by a driver of a mobile inventory containing products which can be purchased through the platform to facilitate managing their inventory and distribution. The distributor account may also keep track of past orders, feedback, and other related information for assisting with client selection of distributors on the disclosed platform. Furthermore, distributors may manage their payments through their distributor account.

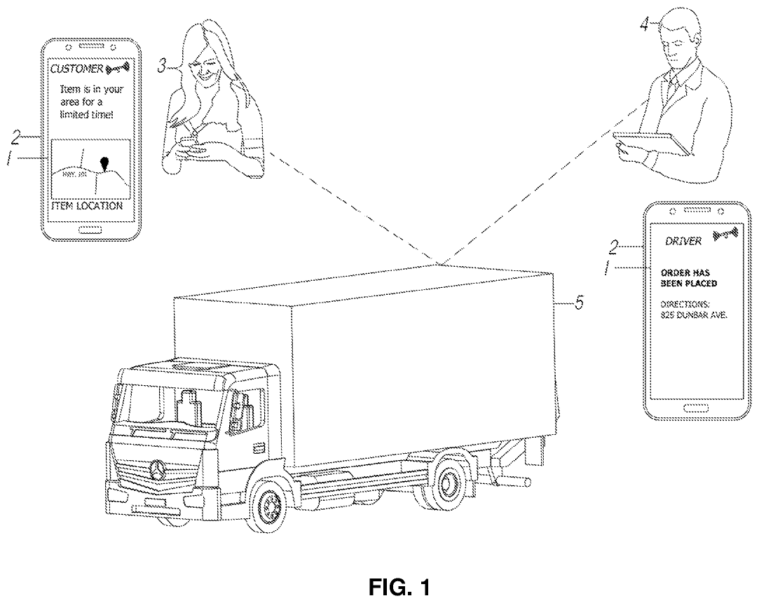

Referring to FIG. 1, an example interaction carried out according to the system of the present disclosure is shown wherein a client 3 uses their mobile phone device 2 to provide an interface 1 with the e-commerce platform. The interface allows them to view a list of items available on the system from a database, and to search for items they want to purchase. The device 2 may have dedicated application software, i.e. an app, for accessing the platform and interfacing with the system installed thereon.

When the client searches an item, they may also select to use a mobile inventory option which allows them to check a map screen as shown to determine whether a mobile inventory, in this case a lorry 5, carrying the item is in their area. This location information is provided to the system by a corresponding user device 2 connected to the system and carried by a driver 4 of the mobile inventory 5, the driver's device continuously uploads the geographic location of the driver and thus of the inventory to the system.

As can be seen, in the present example the client 3 can see by the interface 1 of their mobile device 2 that the item is indeed nearby, and they are thus given the option to purchase the item from that specific mobile inventory 5 while it is in their area. This request is parsed by the platform and, once the client 3 makes payment, the driver 4 is notified of the order through the interface 1 of their own mobile device 2.

The information associated with the user account of the client 3 will be pulled form a database and the delivery address will be forwarded to the device 2 of the driver 4. In some examples, the application software for accessing the platform may integrate with a map feature on the mobile device, providing not only the delivery address but also the quickest route for reaching the delivery address.

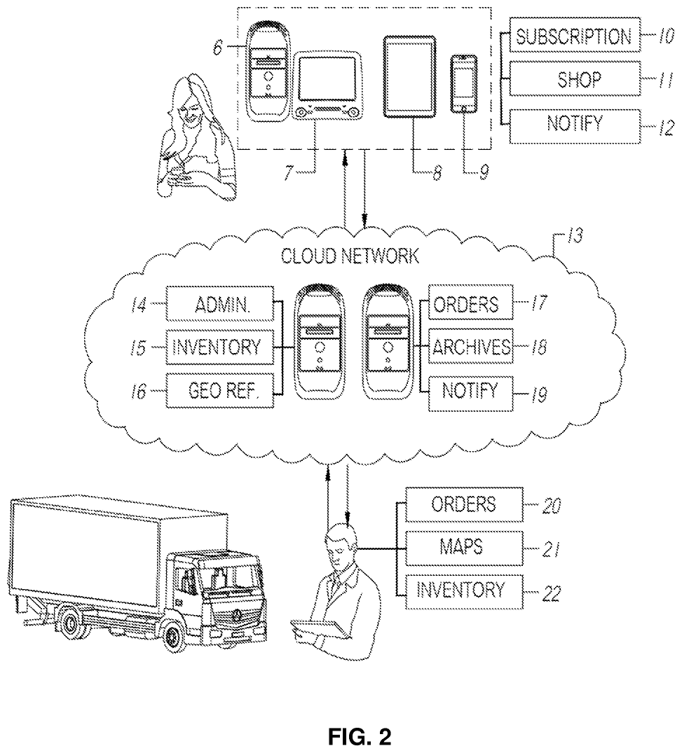

Referring to FIG. 2, a functional overview is shown of an example system according to the present disclosure, and of the network architecture over which it operates.

As can be seen, both the client 3 and the driver 4 interact with the system via their devices communicating over a cloud network 13, with one or more servers or distributed servers and databases that are part of the cloud network 13 implementing the operations of the system.

Devices which are associated with client accounts have at least the following capabilities for interacting with the e-commerce system, including but not limited to: functions for purchasing and managing subscriptions 10 (tracking demographics, managing addresses, inputting and managing payment options, etc.); online shopping 11 (for example the client 3 can browse, search for, and view items available in mobile inventories nearby and across the system via the web portal, make purchases of those items, and enact financial transactions, etc.); and receiving and managing notifications 12 (text, email, SMS etc. for general communications with drivers and merchants, and for generating receipts and confirmation of purchases, etc.).

Devices of drivers which are associated with distributor accounts have a different set of functions available to them via their device interface, that include but are not limited to: receiving orders directly from clients 20 as set out above with reference to FIG. 1; locating clients on existing online maps 21 (google maps etc.) which may be integrated with the platform dedicated application software, such as for example by an application programming interface, API.

Drivers can also manage the mobile inventories 22 as tracked by a database of the cloud infrastructure 13 to ensure that the list of the mobile inventory items available to clients via the platform is kept up to date. This can include replenishment of inventories, changes to stock made after a purchase, exchanges made with other drivers or permanent changes to the list of items stored in a given mobile inventory, and forecasting future items that will soon be available in a given mobile inventory.

The cloud network 13 itself also has its own set of routines and operations that include but are not limited to: administrative functions 14 (maintaining and updating client information associated with client accounts and stored in a database, maintaining and updating driver and company information on the same or a different database, managing payment methods, and maintaining lists and terms for various financial partners etc.); inventory management 15 (supply chain management, distributor communications such as those received from the drivers in the operations laid out above, etc.); geo-referencing 16 (locating inventory items for clients, locating clients for drivers, displaying maps with nearby mobile inventories etc.); enacting order transactions 17 (for example, receiving online payments to the platform from the web portal via payment service providers such as Venmo, PayPal, etc.); and storing data in the archives 18 (for example, transaction histories, accounts data etc.); and managing notifications 19 between clients, distributors, drivers and so on (various forms are possible including but not limited to SMS, text, email etc.).

Also provided herein is an example flow of operations carried out by servers of the cloud architecture of the disclosed system for enacting a transaction between a client and a mobile inventory.

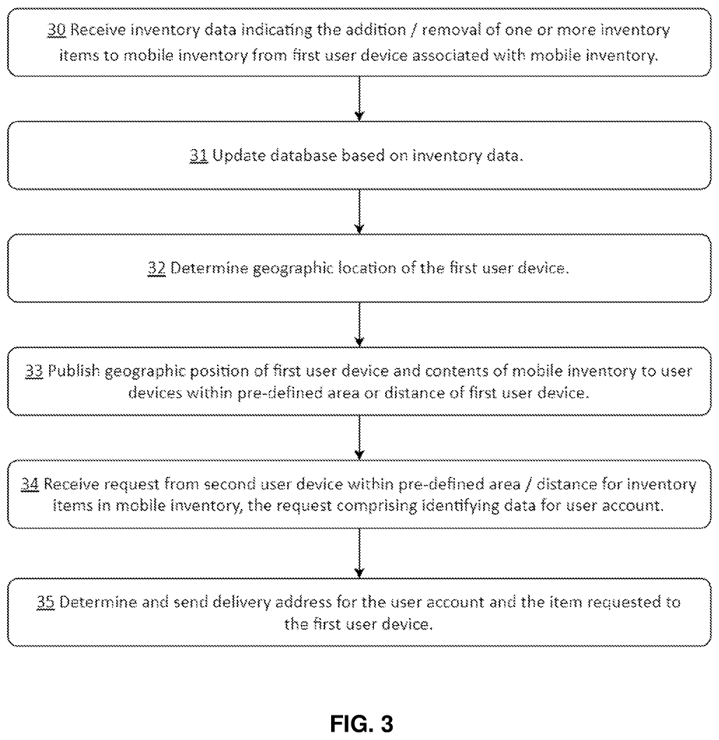

Thus, referring to FIG. 3 a flow chart of an example set of steps carried out by a server in accordance with the system and methods of the present disclosure is shown.

In a first step 30, the method involves receiving inventory data indicating the addition or removal of one or more inventory items to a mobile inventory. The mobile inventory may for example be a lorry, and the update to the inventory data may be performed by a driver of the lorry accessing the system of the present disclosure via their user device in response to a replenishment of stock, exchange of stock, a sale, or for any other reason.

In a second step 31, the method involves updating the database of the system based on the inventory data received form the driver's user device. The list of inventory items in stock available to view on the platform is thus updated and is maintained accurately so that users of the system can determine which mobile inventories have which items in stock with confidence.

In a third step 32, the method involves determining the geographic location of the first user device, and thus of the mobile inventory with which it is associated. Having an up-to date location of the mobile inventory is vital in the operations of the system for allowing clients to purchase items from nearby mobile inventories while in transit.

In a fourth step 33, the method involves publishing (i.e. making accessible via the web portal to the platform of the system) the geographic position of the first user device alongside the contents of the mobile inventory associated with the first user device to other user devices within a pre-defined area or distance from the first user device. This step may involve also determining the location of the clients accessing the system which can be done either via GPS queries to their own devices, or from user account information associated with the clients.

Steps 30-33 are not necessarily performed in order, or only once each. For example, the system may regularly determine the location of the first user device at predetermined intervals, updating the location on the website periodically, but only update the database in response to updates received from mobile inventory drivers.

In a fifth step 34, the method involves receiving a request from a second user device, i.e. that of a client wishing to purchase an item, within the pre-defined area or distance of the first user device for one or more inventory items contained in the associated mobile inventory. The request will comprise identifying data for a user account stored on the database or a live GPS location of the second user device so that it can be determined which mobile inventories are nearby to the client.

In a sixth step 35, the method involves determining and sending a delivery address for the user account and the item requested to the first user device, i.e. to the driver of the mobile inventory, thus allowing an efficient fulfillment of the client order to be made. This sixth step may be preceded by awaiting for confirmation of the purchase and payment for the item by the second user device of the client.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units, system memory, and bus that couples various system components including system memory to processor. Processor may include software module that performs the methods described herein. The module may be programmed into the integrated circuits of processor, or loaded from memory, storage device, or network or combinations thereof. The Bus may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus. Enhanced ISA (EISA) bus, Video Electronics Standards Association (VESA) local bus, and Peripheral Component Interconnects (PCI) bus. Computer system may include a variety of computer system readable media. Such media may be any available media that is accessible by computer system, and it may include both volatile and non-volatile media, removable and non-removable media. System memory can include computer system readable media in the form of volatile memory, such as random-access memory (RAM) and/or cache memory or others. Computer system may further include other removable/non-removable volatile/non-volatile computer system storage media. By way of example only, storage devices can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus by one or more data media interfaces.

Computer system may also communicate with one or more external devices such as a keyboard, a pointing device, a display, etc; one or more devices that enable a user to interact with computer system; and/or any devices (e.g., network card, modem, etc.) that enable computer system to communicate with one or more other computing devices. Such communication can occur via Input/Output (I/O) interfaces. Still yet, computer system can communicate with one or more networks such as a local area network (LAN), a general wide area network (WAN), and/or a public network (e.g., the Internet) via network adapter. As depicted, network adapter communicates with the other components of computer system via bus. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc. As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon. Any combination of one or more computer readable medium(s) may be utilized.

The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to some embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention.

The embodiment was chosen and described in order to best explain the principles of the invention and the practical application, and to enable others of ordinary skill in the art to understand the invention for various embodiments with various modifications as are suited to the particular use contemplated. Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided. The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc. Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. A system for dynamically managing a mobile inventory, the system comprising:
a plurality of user devices;
a database configured to store data on the contents of a plurality of mobile inventories and to store user data for a plurality of user accounts, one or more of the user account being associated with a respective mobile inventory; and
one or more servers in communication with the plurality of user devices and the database, the one or more servers being configured to:
receive inventory data indicating the addition or removal of one or more inventory items to a mobile inventory from a first user device associated with the mobile inventory;
update the database based on the inventory data;
determine the geographic location of the first user device;
publish the geographic position of the first user device alongside the contents of the mobile inventory associated with the first user device to other user devices within a pre-defined area or distance from the first user device;
receive a request from a second user device within the pre-defined area or distance of the first user device for one or more inventory items contained in the associated mobile inventory, the request comprising identifying data for a user account stored on the database; and
determine and send a delivery address for the user account and the item requested to the first user device.

2. A system for dynamically managing a mobile inventory according to claim 1, wherein the one or more servers are configured in coordination with the database to make accessible to the user devices a searchable list of inventory items, the distance of each inventory item from a user device accessing the list being calculated and displayed in real-time based on the geographic location of the user device and the geographic location of each user device associated with a mobile inventory containing the items.

3. A system for dynamically managing a mobile inventory according to claim 2, wherein in the case that an item on the searchable list is not within a predefined distance radius of a user device accessing the list, the one or more servers are further configured to determine one or more similar items which are within the radius and present them to the user device.

4. A system for dynamically managing a mobile inventory according to claim 1, wherein the one or more servers are further configured to display the positions of each mobile inventory within a pre-defined distance radius on a map to the one or more user devices based on the geographic positions of the user devices associated with the mobile inventories and the geographic position of the user device accessing the map.

5. A system for dynamically managing a mobile inventory according to claim 1, wherein the one or more servers are further configured to enable user devices having associated mobile inventories to coordinate and exchange inventory items.

6. A system for dynamically managing a mobile inventory according to claim 1, wherein the request is a purchase order and the one or more servers are further configured to transact the purchase prior to notifying the first user device of the request.

7. A system for dynamically managing a mobile inventory according to claim 1, wherein the one or more servers and the database are part of a distributed cloud architecture.

8. A system for dynamically managing a mobile inventory according to claim 1, wherein each user device associated with a mobile inventory is further provided with point-of-sale capabilities to facilitate the sale of additional inventory items on-location.
